(19) United States
(12) Patent Application Publication
(10) Pub. No.: US 2020/0379087 A1
(43) Pub. Date: Dec. 3, 2020

(54) METHOD AND SYSTEM FOR GENERATING RADAR REFLECTION POINTS

(71) Applicant: Robert Bosch GmbH, Stuttgart (DE)

(72) Inventors: Chun Yang, Budapest (HU); Sebastian Muenzner, Leonberg (DE); Zoltan Karasz, Budapest (HU); Fabian Timm, Renningen (DE); Jasmin Ebert, Rutesheim (DE); Laszlo Anka, Heilbronn (DE)

(21) Appl. No.: 16/878,814

(22) Filed: May 20, 2020

(30) Foreign Application Priority Data
May 27, 2019 (EP) 19176838.1

(51) Int. Cl. G01S 7/41; G01S 13/89

(52) U.S. Cl. CPC G01S 7/412; G01S 13/89; G01S 7/417

(57) ABSTRACT

A method for generating radar reflection points comprising the steps of: providing a plurality of predefined radar reflection points of at least one first object detected by a radar and at least one first scenario description describing a first environment related to the detected first object; converting the predefined radar reflection points into at least one first power distribution pattern image related to a distribution of a power returning from the detected first object; training a model based on the first power distribution pattern image and the first scenario description; providing at least one second scenario description describing a second environment related to a second object; generating at least one second power distribution pattern image related to a distribution of a power returning from the second object based on the trained model and the second scenario description; and sampling the second power distribution pattern image.

### CROSS REFERENCE

The present application claims the benefit under 35 U.S.C. § 119 of European Patent Application EP 19176838.1 filed on May 27, 2019, which is expressly incorporated herein by reference in its entirety.

### FIELD

The present invention relates to a method and a system for generating radar reflection points as well as a computer program comprising instructions which, when the program is executed by a computer, cause the computer to carry out the method.

### BACKGROUND INFORMATION

Radar simulation is important for radar function development and verification purposes, such as driver assistance, sensor fusion and automated driving at a vehicle. Existing radar models are typically black- or white-box. Black-box models represent radar return in a stochastic manner. White-box models use ray-tracing for estimating electromagnetic path propagation and typically rely on object radar cross section values being given, or for extracting virtual scattering centers as, e.g., described in the article “Extraction of virtual scattering centers of vehicles by ray-tracing simulations” by K. Schuler et al. White-box models require detailed models of environment to capture important radar-related effects such as multipath propagation and interference. However, models with sufficient details are often not available, and the extensive computations which are required accordingly render a real-time simulation infeasible.

A deep stochastic radar model (“DSRM” hereafter) is described for automotive radar simulations in the article “Deep Stochastic Radar Models” by Tim A. et al. which consists of a plurality of sub-models. DSRM allows for arbitrary roadway configurations and scene composition through the use of a terrain raster grid and an object list as inputs. DSRM produces power return fields that exhibit radar phenomena without explicit programming and runs in real-time. Although DSRM demonstrates the advantage of neural networks in radar data processing, there is still one drawback that the application of this model is limited in real radar devices due to the fact that the input and output of this model are special raw data, i.e., the data before the ambiguity resolution, clustering and/or object tracking. In this regard, these raw data are unable to be directly used for further development of radar simulation functions.

### SUMMARY

The present invention provides a method for generating radar reflection points, a system for generating radar reflection points, and a computer program.

Further advantageous embodiments and improvements of the present invention are described herein.

The present invention provides, according to a first aspect, an example method for generating radar reflection points comprising the steps of: providing a plurality of predefined radar reflection points of at least one first object detected by a radar and at least one first scenario description describing a first environment related to the detected first object; converting the predefined radar reflection points into at least one first power distribution pattern image related to a distribution of a power returning from the detected first object; training a model based on the first power distribution pattern image and the first scenario description; providing at least one second scenario description describing a second environment related to a second object; generating at least one second power distribution pattern image related to a distribution of a power returning from the second object based on the trained model and the second scenario description; and sampling the second power distribution pattern image.

It is favorable that by means of the example method according to the present invention, radar simulation used for outputting the final detection results of a radar, i.e., radar reflection points, is technically realized. Unlike the DSRM mentioned above to which real radar reflection points and/or object lists cannot be directly applied due to the sparseness of the spatial data, the example method in accordance with the present invention may advantageously utilize real radar reflection points as input in order to train a model for the subsequent generation of radar reflection points.

The real radar reflection points are converted to a power distribution pattern image which is a kind of radar images. Radar reflection points are the radar output after a certain signal processing performed on a raw image received by a radar. This raw image is basically a distribution of power returning to the radar. After the signal processing such as object detection, ambiguity resolution and object tracking, some information is lost. In this regard, on one hand, it is impossible to recover the radar raw image exactly, and on the other hand, it may make less sense by doing so because the radar raw image can be hardly used directly due to some ambiguities embedded in the raw image. In this case, the example method according to the present invention converts real radar reflection points which were obtained from a real radar raw image to a power distribution pattern image which can reflect the real power distribution received by the radar to some extent, but without any object ambiguities.

In addition, in accordance with the present invention, the computational complexity and costs during radar simulation processes are significantly reduced. Once the training of the model is complete, the example method in accordance with the present invention may achieve a nearly real-time generation of radar reflection points with a scenario description as an input of the trained model.

Furthermore, with the help of the example method according to the present invention, the radar simulation may adapt to arbitrary roadway topologies and scene configurations as the environment of a target object inclusive of the target object itself since the training of the model is directed to arbitrary roadway topologies and scene configurations.

In a preferable embodiment of the present invention, the step of converting the predefined radar reflection points into at least one first power distribution pattern image comprises: converting each of the predefined radar reflection points into a third power distribution pattern image related to a distribution of a power returning from an area around the each of the predefined radar reflection points; and merging the third power distribution pattern images to form the first power distribution pattern image. Thereby, all the real radar reflection points as the predefined radar reflection points are converted to a power distribution pattern image which reflects the real power distribution received by the radar to some extent, but without any object ambiguities.

In a further preferable embodiment of the present invention, the step of converting each of the predefined radar reflection points into a third power distribution pattern image comprises implementing a sinc function using the each of the predefined radar reflection points as the variable of the sinc function in the longitudinal and/or lateral direction corresponding to the relative position between the radar and the first object. Thereby, the generated power distribution pattern image is similar to the real power distribution image received by the radar since essentially the radar output after signal processing has a sinc form, either along the longitudinal or lateral direction. The position and value of the peak of the sinc function represent the position and the radar cross section of the reflection point, respectively. The 3 dB bandwidth of the sinc function is determined by the measuring accuracy of the radar.

In a further preferable embodiment of the present invention, the first and second scenario description comprise spatial data related to the first and/or second object, in particular represented by a raster, and an object list, in particular with features of the first and/or second object. The spatial data and object lists are both complex and multi-dimensional in order to, e.g., capture the full space of driving scenes for a vehicle. Compared with traditional parametric radar models, the present method is able to handle such complicated inputs.

In a further preferable embodiment of the present invention, the first and second scenario description are identical. Thereby, more radar reflection points are generated for the same scenario in order to, e.g., increase the dataset for this scenario.

Alternatively, the second scenario description may be different from the first scenario description in order to generate radar reflection points for a new scenario. In this case, scenario characters describing a scenario indicated in the second scenario description should be used as a part of the first scenario description in the training step.

In a further preferable embodiment of the present invention, the step of training the model comprises training a deep neural network. Thereby, robust hierarchical features from complicated inputs, i.e., the spatial data and object lists, can be automatically learned. Furthermore, a deep neural network is efficient to use once being trained.

In a further preferable embodiment of the present invention, the step of generating the second power distribution pattern image is in addition based on a noise value, in particular randomly generated. Since noises bring inaccuracies to a real radar, the example method in accordance with the present invention generates radar reflection points exhibiting the same inaccuracies as if these radar reflection points were from a real radar. Thereby, the radar simulation is improved.

The present invention further provides, according to a second aspect, an example system for generating radar reflection points comprising an image conversion preparation unit configured to provide a plurality of predefined radar reflection points of at least one first object detected by a radar and at least one first scenario description describing a first environment related to the detected first object, an image conversion unit configured to convert the predefined radar reflection points into at least one first power distribution pattern image related to a distribution of a power returning from the detected first object, a training unit configured to train a model based on the first power distribution pattern image and the first scenario description, a scenario description providing unit configured to provide at least one second scenario description describing a second environment related to a second object, an image generation unit configured to generate at least one second power distribution pattern image related to a distribution of a power returning from the second object based on the trained model and the second scenario description, and a sampling unit configured to sample the second power distribution pattern image.

The present invention further provides, according to a third aspect, an example computer program comprising instructions which, when the program is executed by a computer, cause the computer to carry out the method according to the first aspect of the present invention.

### BRIEF DESCRIPTION OF THE DRAWINGS

Further advantageous details and features may be taken from the following description of several exemplary embodiments of the present invention in conjunction with the figures.

FIG. 1 shows a block diagram of an embodiment of the example method for generating radar reflection points in accordance with the present invention.

FIG. 2 shows a schematic representation of converted power distribution pattern images and generated power distribution pattern images using the embodiment of the example method according to FIG. 1.

FIG. 3 shows a schematic representation of predefined/real radar reflection points and generated radar reflection points using the embodiment of the example method according to FIG. 1.

FIG. 4 shows a block diagram of an embodiment of the example system for generating radar reflection points in accordance with the present invention.

FIG. 5 shows a block diagram of an embodiment of the example computer program in accordance with the present invention comprising instructions which, when the program is executed by a computer, cause the computer to carry out the embodiment of the example method according to FIG. 1.

### DETAILED DESCRIPTION OF EXAMPLE EMBODIMENTS

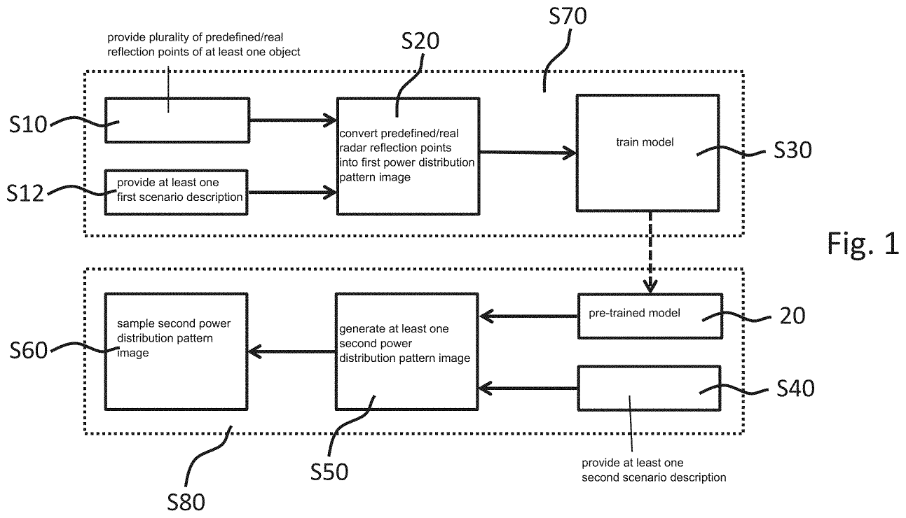

The example embodiment of an example method in accordance with the present invention for generating radar reflection points shown in FIG. 1 comprises steps S10, S12, S20, S30, S40, S50, S60. In the step S10, a plurality of predefined/real radar reflection points of at least one first object detected by a radar is provided. In the step S12, at least one first scenario description describing a first environment related to the detected first object is provided. In the step S20, the predefined/real radar reflection points are converted into at least one first power distribution pattern image related to a distribution of a power returning from the detected first object. In the step S30, a model is trained based on the first power distribution pattern image and the first scenario description. In the step S40, at least one second scenario description describing a second environment related to a second object is provided. In the step S50, at least one second power distribution pattern image related to a distribution of a power returning from the second object is generated based on the trained model and the second scenario description. In the step S60, the second power distribution pattern image is sampled to generate radar reflection points.

The steps S10, S12, S20 and S30 form a training stage S70 after which a pre-trained model 20 is generated. The steps S40, S50 and S60 form a deployment stage in order to output radar reflection points based on scenario descriptions inputted in the pre-trained model 20.

In the step S30 of the example embodiment shown in FIG. 1, DSRM is applied for training due to its ability to automatically learn robust hierarchical features from complicated inputs and its high efficiency once being trained.

In the step S60 of the example embodiment shown in FIG. 1, a simple random sampling is adopted. Correspondingly, the generated radar reflection points are expected in the normal/Gaussian distribution.

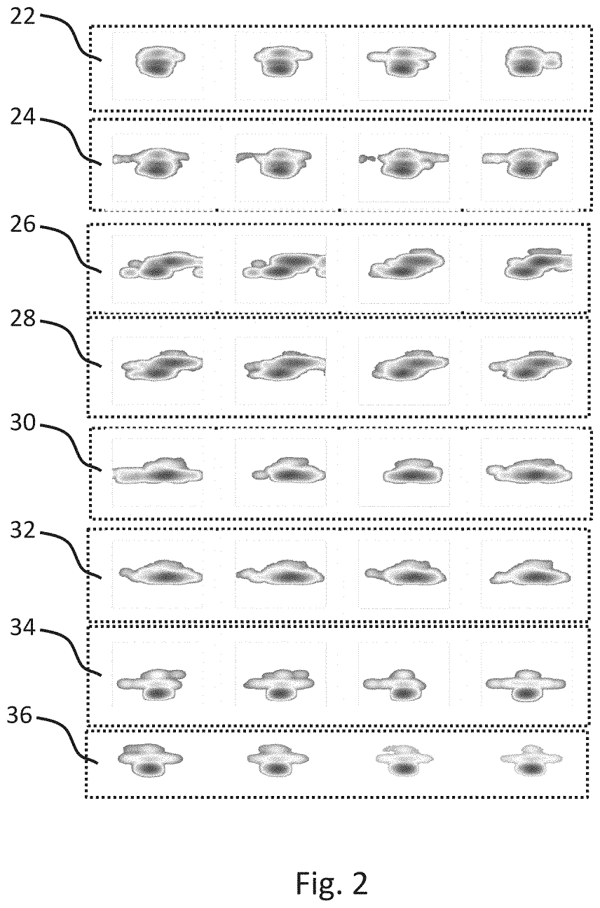

Rows 22, 26, 30, 34 shown in FIG. 2 represent power distribution pattern images converted from real radar reflection points of a vehicle as the detected object in different orientations, respectively. Rows 24, 28, 32, 36 shown in FIG. 2 represent power distribution pattern images generated using the model of the embodiment according to FIG. 1 which is trained by means of the power distribution pattern images in the Rows 22, 26, 30, 34, and using the same scenario description as the one for the previous training of the model.

By comparing row 22 with row 24, row 26 with row 28, row 30 with row 32, row 34 with row 36, it is clear that the generated power distribution pattern images have the same or at least very similar distribution as the power distribution pattern images converted from the real radar data.

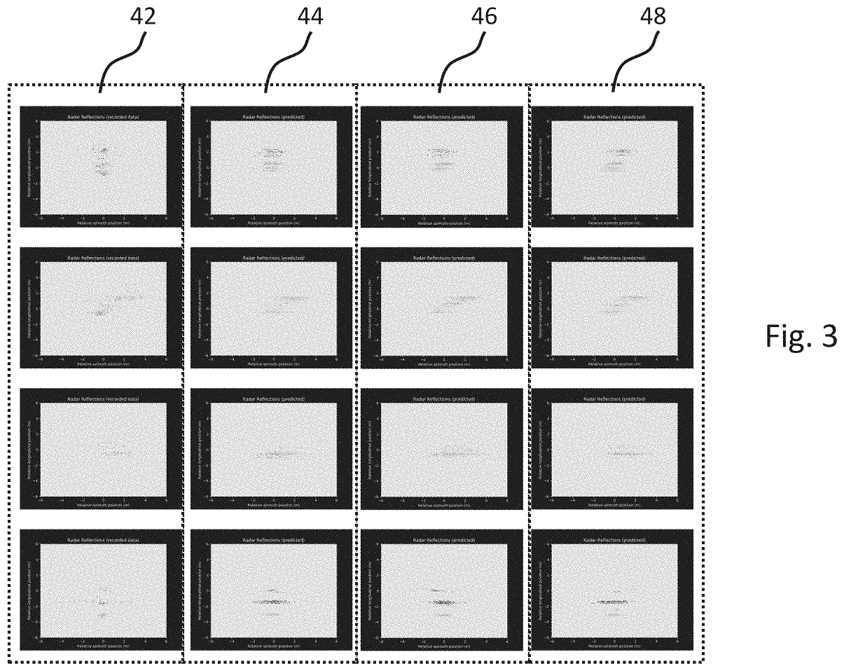

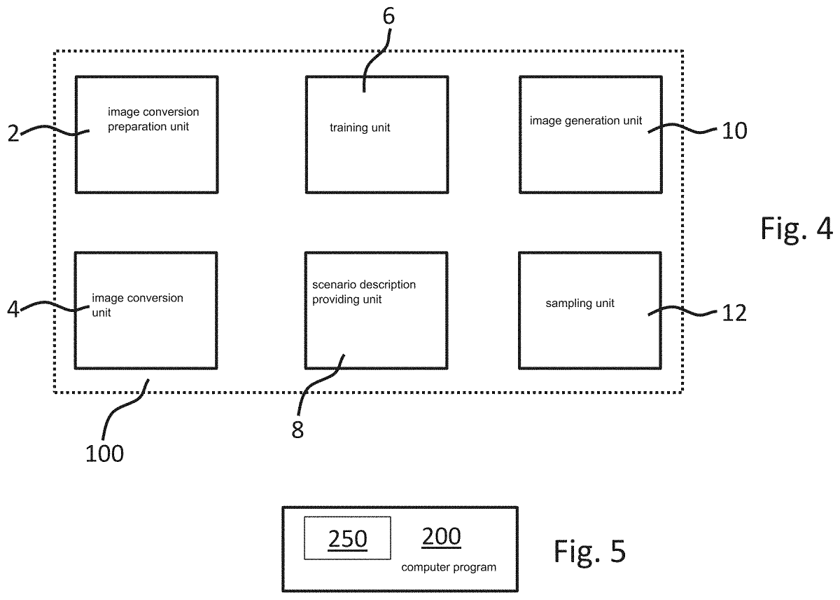

Column 42 shown in FIG. 3 represents real radar reflection points of the vehicle as the detected object in four different orientations. Columns 44, 46, 48 shown in FIG. 3 represent, respectively, radar reflection points generated by sampling the generated power distribution pattern images as the output of the trained model of the embodiment according to FIG. 1.

By comparing column 42 with column 44, 46, 48, it is clear that the generated radar reflection points in accordance with the present invention have the same or at least very similar distribution as the real radar data.

An example embodiment of a system 100 in accordance with the present invention for generating radar reflection points comprises an image conversion preparation unit 2 configured to provide a plurality of predefined radar reflection points of at least one first object detected by a radar and at least one first scenario description describing a first environment related to the detected first object, an image conversion unit 4 configured to convert the predefined radar reflection points into at least one first power distribution pattern image related to a distribution of a power returning from the detected first object, a training unit 6 configured to train a model based on the first power distribution pattern image and the first scenario description, a scenario description providing unit 8 configured to provide at least one second scenario description describing a second environment related to a second object, an image generation unit 10 configured to generate at least one second power distribution pattern image related to a distribution of a power returning from the second object based on the trained model and the second scenario description, and a sampling unit 12 configured to sample the second power distribution pattern image.

The example embodiment of the computer program 200 in accordance with the present invention shown in FIG. 5 comprises instructions 250 which, when the program 200 is executed by a computer, cause the computer to carry out the embodiment of the example method shown in FIG. 1.

The present invention is described and illustrated in detail by the preferable embodiments mentioned above. However, the present invention is not limited by the disclosed examples, and other variations can be derived therefrom while still being inside the protection scope of the present invention.

What is claimed is:

1. A method for generating radar reflection points, comprising the following steps:
providing a plurality of predefined radar reflection points of at least one first object detected by a radar and at least one first scenario description describing a first environment related to the detected first object;
converting the predefined radar reflection points into at least one first power distribution pattern image related to a distribution of a power returning from the detected first object;
training a model based on the first power distribution pattern image and the first scenario description;
providing at least one second scenario description describing a second environment related to a second object;
generating at least one second power distribution pattern image related to a distribution of a power returning from the second object based on the trained model and the second scenario description; and
sampling the second power distribution pattern image.

2. The method according to claim 1, wherein the step of converting the predefined radar reflection points into the at least one first power distribution pattern image includes:
converting each of the predefined radar reflection points into a third power distribution pattern image related to a distribution of a power returning from an area around the each of the predefined radar reflection points; and
merging the third power distribution pattern images to form the first power distribution pattern image.

3. The method according to claim 2, wherein the step of converting each of the predefined radar reflection points into the third power distribution pattern image includes:
implementing a sinc function using the each of the predefined radar reflection points as a variable of the sinc function in a longitudinal and/or lateral direction corresponding to a relative position between a radar and the first object.

4. The method according to claim 1, wherein the first and second scenario description include spatial data related to the first and/or second object represented by a raster, and an object list with features of the first object and/or second object.

5. The method according to claim 1, wherein the first scenario description and the second scenario description are identical to one another.

6. The method according to claim 1, wherein the step of training the model includes training a deep neural network.

7. The method according to claim 1, wherein the step of generating the second power distribution pattern image is in addition based on a randomly generated noise value.

8. A system for generating radar reflection points, comprising:
an image conversion preparation unit configured to provide a plurality of predefined radar reflection points of at least one first object detected by a radar and at least one first scenario description describing a first environment related to the detected first object;
an image conversion unit configured to convert the predefined radar reflection points into at least one first power distribution pattern image related to a distribution of a power returning from the detected first object;
a training unit configured to train a model based on the first power distribution pattern image and the first scenario description;
a scenario description providing unit configured to provide at least one second scenario description describing a second environment related to a second object;
an image generation unit configured to generate at least one second power distribution pattern image related to a distribution of a power returning from the second object based on the trained model and the second scenario description; and
a sampling unit configured to sample the second power distribution pattern image.

9. A non-transitory machine-readable memory medium on which is stored a computer program for generating radar reflection points, the computer program, when executed by a computer, causing the computer to perform the following steps:
providing a plurality of predefined radar reflection points of at least one first object detected by a radar and at least one first scenario description describing a first environment related to the detected first object;
converting the predefined radar reflection points into at least one first power distribution pattern image related to a distribution of a power returning from the detected first object;
training a model based on the first power distribution pattern image and the first scenario description;
providing at least one second scenario description describing a second environment related to a second object;
generating at least one second power distribution pattern image related to a distribution of a power returning from the second object based on the trained model and the second scenario description; and
sampling the second power distribution pattern image.
